(19) United States
(12) Patent Application Publication
(10) Pub. No.: US 2021/0377125 A1
(43) Pub. Date: Dec. 2, 2021

(54) Network Topology Discovery Method, Device, and System

(71) Applicant: Huawei Technologies Co., Ltd., Shenzhen (CN)

(72) Inventors: Juan Zheng, Nanjing (CN); Ting Liao, Nanjing (CN); Qing Yang, Nanjing (CN)

(21) Appl. No.: 17/334,121

(22) Filed: May 28, 2021

(30) Foreign Application Priority Data
May 30, 2020 (CN) 202010480856.9
Aug. 19, 2020 (CN) 202010839707.7

(51) Int. Cl. H04L 12/24

(52) U.S. Cl. CPC H04L 41/12; H04L 41/0293; H04L 41/0213

(57) ABSTRACT

A network topology discovery method, includes: A second network device receives a first LLDP packet sent by a first network device. The first LLDP packet includes first slice information, and the first slice information is used to indicate a network slice to which a first port of the first network device belongs. The second network device sends the first slice information and second slice information to a management device. The second slice information is used to indicate a network slice to which a second port of the second network device belongs.

### CROSS-REFERENCE TO RELATED APPLICATIONS

This claims priority to Chinese Patent App. No. 202010839707.7, filed on Aug. 19, 2020, which claims priority to Chinese Patent App. No. 202010480856.9, filed on May 30, 2020, both of which are incorporated by reference.

### FIELD

This disclosure relates to the field of communications technologies, and in particular, to a network topology discovery method, device, and system.

### BACKGROUND

Network slicing is an on-demand networking mode. Specifically, a network slice is a virtual network separated from a physical network. A plurality of network slices may be separated from a same physical network. Logical isolation may be implemented between network slices, to adapt to various types of applications.

The Link Layer Discovery Protocol (LLDP) is a link layer (layer 2) discovery protocol defined by Institute of Electrical and Electronics Engineers IEEE) 802.1AB. A network device may advertise a status of the network device to another network device by sending, in a network, an LLDP packet carrying an LLDP data unit (LLDPDU). Therefore, the LLDP is a protocol that enables network devices in the network to discover each other, advertise their own statuses, and exchange information.

The network device in the network obtains status information of a neighboring network device of the network device through an LLDP packet. In addition, the network device may send the obtained status information of the neighboring network device and status information of the network device to a management device. In this way, the management device can determine topology information of the network based on the obtained status information of the plurality of network devices. However, when the network includes a network slice, the management device cannot determine topology information of the network slice based on the obtained status information of the plurality of network devices.

### SUMMARY

This disclosure provides a network topology discovery method, device, and system, so that a management device can obtain slice information of a managed device.

According to a first aspect, a network topology discovery method is provided. The method includes: A second network device receives a first LLDP packet sent by a first network device. The first LLDP packet includes first slice information, and the first slice information is used to indicate a network slice to which a first port of the first network device belongs. Then, the second network device sends the first slice information and second slice information to a management device. The second slice information is used to indicate a network slice to which a second port of the second network device belongs.

Based on the solution provided, slice information can be advertised between LLDP neighboring devices, and the LLDP neighboring devices can report the slice information to the management device, to help the management device obtain slice information of a managed device in a timely manner and determine topology information of the network slices.

In a possible implementation of the first aspect, before the second network device sends the first slice information and the second slice information to the management device, the method includes: The second network device receives a request message sent by the management device. The request message is used by the management device to request slice information from a network device managed by the management device.

In another possible implementation of the first aspect, before the second network device sends the first slice information and the second slice information to the management device, the method includes: The second network device sends a first notification message to the management device. The first notification message includes the first slice information and the second slice information.

In still another possible implementation of the first aspect, the method further includes: The second network device receives a third LLDP packet sent by the first network device. The third LLDP packet includes third slice information, the third slice information is used to indicate a network slice to which the first port of the first network device belongs at a second moment, the first slice information is used to indicate a network slice to which the first port of the first network device belongs at a first moment, and the first moment is different from the second moment. The second network device sends the third slice information to the management device.

In still another possible implementation of the first aspect, that the second network device sends the third slice information to the management device includes: The second network device sends a second notification message to the management device. The second notification message includes the third slice information.

In still another possible implementation of the first aspect, the method further includes: The second network device sends a second LLDP packet to the first network device. The second LLDP packet includes the second slice information.

In still another possible implementation of the first aspect, the first slice information includes a first slice identifier, the first slice identifier is used to identify the network slice to which the first port belongs, the second slice information includes a second slice identifier, the second slice identifier is used to identify the network slice to which the second port belongs, the first port is a receive port of the second LLDP packet, and the second port is a receive port of the first LLDP packet. The method further includes: The second network device determines whether the first slice identifier is the same as the second slice identifier.

In still another possible implementation of the first aspect, the method further includes: The second network device generates alarm information in response to that the first slice identifier is different from the second slice identifier. The alarm information is used to indicate that slice information of the first port does not match slice information of the second port.

In still another possible implementation of the first aspect, the method further includes: The second network device stores the first slice information in response to that the first slice identifier is the same as the second slice identifier.

According to a second aspect, a network topology discovery method is provided. The method includes: A management device receives first slice information and second slice information that are sent by a second network device. The first slice information is used to indicate a network slice to which a first port of the first network device belongs, and the second slice information is used to indicate a network slice to which a second port of the second network device belongs. In addition, the management device receives the first slice information and the second slice information that are sent by the first network device. Then, the management device determines, based on the first slice information and the second slice information that are received from the first network device and the first slice information and the second slice information that are received from the second network device, topology information of the network slices to which the first port and the second port belong.

Based on the solution provided, an LLDP neighboring device can report slice information to the management device, to help the management device obtain slice information of a managed device and determine the topology information of the network slices in a timely manner.

In a possible implementation of the second aspect, before the management device receives the first slice information and the second slice information that are sent by a second network device, the method further includes: The management device sends a request message to the second network device. The request message is used by the management device to request slice information from a network device managed by the management device.

In another possible implementation of the second aspect, that a management device receives first slice information and second slice information that are sent by a second network device includes: The management device receives a first notification message sent by the second network device. The first notification message includes the first slice information and the second slice information.

In still another possible implementation of the second aspect, the method further includes: The management device receives third slice information sent by the second network device. The third slice information is used to indicate a network slice to which the first port of the first network device belongs at a second moment, the first slice information is used to indicate a network slice to which the first port of the first network device belongs at a first moment, and the first moment is different from the second moment. The management device updates, based on the third slice information and the second slice information, the topology information of the network slices to which the first port and the second port belong.

In yet another possible implementation of the second aspect, that the management device receives third slice information sent by the second network device includes: The management device receives a second notification message sent by the second network device. The second notification message includes the third slice information.

In still yet another possible implementation of the second aspect, the first network device is an LLDP neighbor of the second network device.

In the first aspect or the second aspect, optionally, the first slice information includes a first slice identifier, the first slice identifier is used to identify the network slice to which the first port belongs, the second slice information includes a second slice identifier, the second slice identifier is used to identify the network slice to which the second port belongs, and the first slice identifier is the same as the second slice identifier.

In the first aspect or the second aspect, optionally, the first slice information further includes a first device identifier and a first port identifier, the first device identifier is used to indicate the first network device, the first port identifier is used to indicate the first port of the first network device, the second slice information further includes a second device identifier and a second port identifier, the second device identifier is used to indicate the second network device, and the second port identifier is used to indicate the second port of the second network device.

In the first aspect or the second aspect, optionally, the first slice information further includes a first port bandwidth, the first port bandwidth is used to indicate an available bandwidth of the first port, the second slice information further includes a second port bandwidth, and the second port bandwidth is used to indicate an available bandwidth of the second port.

In the first aspect or the second aspect, optionally, the topology information of the network slice to which the first port and the second port belong includes the first slice identifier.

According to a third aspect, a second network device is provided. The second network device has a function of implementing actions of the second network device in the foregoing methods. The function may be implemented based on hardware, or may be implemented based on hardware executing corresponding software. The hardware or the software includes one or more modules corresponding to the foregoing function.

In a possible design, a structure of the second network device includes a processor and an interface. The processor is configured to support the second network device in implementing corresponding functions in the foregoing methods. The interface is configured to: support communication between the second network device and another network device, and receive information or instructions in the foregoing methods from the another network device. The interface is further configured to support communication between the second network device and the management device. The second network device may further include a memory. The memory is configured to be coupled to the processor, and store program instructions and data that are for the second network device.

In another possible design, the second network device includes a processor, a transmitter, a receiver, a random access memory, a read-only memory, and a bus. The processor is coupled to the transmitter, the receiver, the random access memory, and the read-only memory through the bus. When the second network device needs to run, a basic input/output system built into a read-only memory or a bootloader in an embedded system is used to boot the system to start, and boot the second network device to enter a normal running state. After the second network device enters the normal running state, an application program and an operating system are run in the random access memory, to enable the processor to perform the method in any one of the first aspect or the possible implementations of the first aspect.

According to a fourth aspect, a second network device is provided. The second network device includes a main control board and an interface board, and may further include a switching board. The second network device is configured to perform the method in any one of the first aspect or the possible implementations of the first aspect. Specifically, the second network device includes modules configured to perform the method in any one of the first aspect or the possible implementations of the first aspect.

According to a fifth aspect, a second network device is provided. The second network device includes a controller and a first forwarding sub-device. The first forwarding sub-device includes an interface board, and may further include a switching board. The first forwarding sub-device is configured to perform a function of the interface board in the fourth aspect, and may further perform a function of the switching board in the fourth aspect. The controller includes a receiver, a processor, a transmitter, a random access memory, a read-only memory, and a bus. The processor is coupled to the receiver, the transmitter, the random access memory, and the read-only memory through the bus. When the controller needs to run, a basic input/output system built into a read-only memory or a bootloader in an embedded system is used to boot the system to start, and boot the controller to enter a normal running state. After the controller enters the normal running state, an application program and an operating system are run in the random access memory, to enable the processor to implement functions of the main control board in the fourth aspect.

According to a sixth aspect, a computer storage medium is provided. The computer storage medium is configured to store a program, code, or instructions used by the foregoing second network device. When executing the program, the code, or the instructions, a processor or a hardware device can complete functions or steps of the second network device in the first aspect.

According to a seventh aspect, a management device is provided. The management device has a function of implementing a device management action in the foregoing method. The function may be implemented based on hardware, or may be implemented based on hardware executing corresponding software. The hardware or the software includes one or more modules corresponding to the foregoing function.

In a possible design, a structure of the management device includes a processor and an interface. The processor is configured to support the management device in implementing corresponding functions in the foregoing methods. The interface is configured to: support communication between the management device and each of the first network device and the second network device, send information or instructions in the foregoing methods to the first network device and the second network device, or receive information or instructions in the foregoing methods that are sent by the first network device and the second network device. The management device may further include a memory. The memory is configured to be coupled to the processor, and store program instructions and data that are for the management device.

In another possible design, the management device includes a processor, a transmitter, a receiver, a random access memory, a read-only memory, and a bus. The processor is coupled to the transmitter, the receiver, the random access memory, and the read-only memory through the bus. When the management device needs to run, a basic input/output system built into a read-only memory or a bootloader in an embedded system is used to boot the system to start, and boot the management device to enter a normal running state. After the management device enters the normal running state, an application program and an operating system are run in the random access memory, to enable the processor to perform the method in any one of the second aspect or the possible implementations of the second aspect.

According to an eighth aspect, a management device is provided. The management device includes a main control board and an interface board, and may further include a switching board. The management device is configured to perform the method in any one of the second aspect or the possible implementations of the second aspect. Specifically, the management device includes modules configured to perform the method in any one of the second aspect or the possible implementations of the second aspect.

According to a ninth aspect, a management device is provided. The management device includes a controller and a second forwarding sub-device. The second forwarding sub-device includes an interface board, and may further include a switching board. The second forwarding sub-device is configured to perform a function of the interface board in the eighth aspect, and may further perform a function of the switching board in the eighth aspect. The controller includes a receiver, a processor, a transmitter, a random access memory, a read-only memory, and a bus. The processor is coupled to the receiver, the transmitter, the random access memory, and the read-only memory through the bus. When the controller needs to run, a basic input/output system built into a read-only memory or a bootloader in an embedded system is used to boot the system to start, and boot the controller to enter a normal running state. After the controller enters the normal running state, an application program and an operating system are run in the random access memory, to enable the processor to implement functions of the main control board in the eighth aspect.

According to a tenth aspect, a computer storage medium is provided. The computer storage medium is configured to store a program, code, or instructions used by the foregoing management device. When executing the program, the code, or the instructions, a processor or a hardware device can complete the functions or steps of the management device in the second aspect.

According to an eleventh aspect, a network system is provided. The network system includes a second network device and a management device. The second network device is the second network device in the third aspect, the fourth aspect, or the fifth aspect, and the management device is the management device in the seventh aspect, the eighth aspect, or the ninth aspect.

In the foregoing solutions, slice information can be advertised between the LLDP neighboring devices, and the LLDP neighboring devices can report the slice information to the management device, to help the management device obtain the slice information of the managed device in a timely manner and determine topology information of the network slices.

### BRIEF DESCRIPTION OF THE DRAWINGS

FIG. 1 is a schematic structural diagram of a communications network according to an embodiment;

FIG. 2 is a schematic structural diagram of another communications network according to an embodiment;

FIG. 3 is a schematic structural diagram of still another communications network according to an embodiment;

FIG. 4A and FIG. 4B are a flowchart of a network topology discovery method according to an embodiment;

FIG. 5 shows a format of an LLDP packet according to an embodiment;

FIG. 6 shows a format of an LLDPDU according to an embodiment;

FIG. 7 shows a format of another LLDPDU according to an embodiment;

FIG. 8 is a schematic structural diagram of a second network device according to an embodiment;

FIG. 9 is a schematic structural diagram of hardware of a second network device according to an embodiment;

FIG. 10 is a schematic structural diagram of hardware of another second network device according to an embodiment;

FIG. 11 is a schematic structural diagram of a management device according to an embodiment;

FIG. 12 is a schematic structural diagram of hardware of a management device according to an embodiment; and

FIG. 13 is a schematic structural diagram of hardware of another management device according to an embodiment.

### DETAILED DESCRIPTION

The following describes the technical solutions in detail by using specific embodiments.

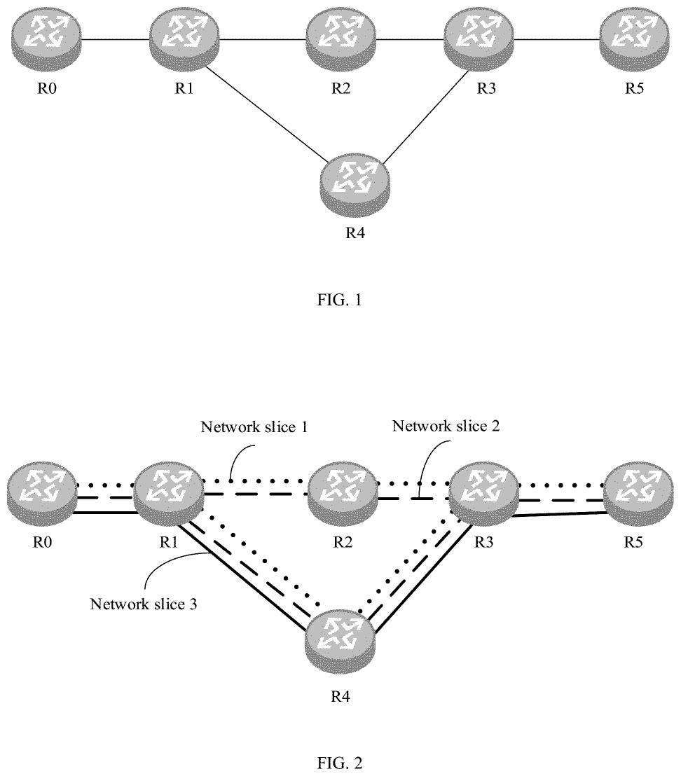

FIG. 1 is a schematic structural diagram of a communications network according to an embodiment. The communications network includes a plurality of network devices. The communications network may be, for example, an Internet Protocol (IP) network. For example, as shown in FIG. 1, the communications network includes a network device R0, a network device R1, a network device R2, a network device R3, a network device R4, and a network device R5. The R0, the R1, the R2, the R3, and the R5 are sequentially connected through communications links, the R1 is further connected to the R4 through a communications link, and the R3 is further connected to the R4 through a communications link. In a possible implementation, communications links between the R0, the R1, the R2, the R3, the R4, and the R5 are physical communications links. The physical communications link may be a cable, an optical fiber, or a wireless link. Ports that connect the R0, the R1, the R2, the R3, the R4, and the R5 to the communications links may be physical ports. In a possible implementation, communications links between the R0, the R1, the R2, the R3, the R4, and the R5 are direct links. The direct link means that two devices (for example, the RO and the R1) are directly connected through a link, and the link between the two devices does not include another forwarding device or processing device but may include a transparent transmission device. The communications network shown in FIG. 1 further includes a management device (which is not shown in FIG. 1). The management device separately communicates with the R0, the R1, the R2, the R3, the R4, and the R5. The management device is responsible for managing the R0, the R1, the R2, the R3, the R4, and the R5. Therefore, the R0, the R1, the R2, the R3, the R4, and the R5 may be considered as managed devices. LLDP can be run on the RO, the R1, the R2, the R3, the R4, and the R5. The R0, the R1, the R2, the R3, the R4, and R5 send LLDP packets to respective neighboring network devices. For example, the R1 may send an LLDP packet to the R2, and the R2 may also send an LLDP packet to the R1. In this way, the R0, the R1, the R2, the R3, the R4, and the R5 can learn of status information of their neighboring network devices based on the LLDP. For example, the R1 includes a local management information base (MIB) and a remote MIB. The local MIB of the R1 is used to store status information of a local network device (for example, the R1), and the remote MIB of the R1 is used to store status information of a neighboring network device (for example, the R2). When the status information of the local network device changes, the local network device extracts status information from the local MIB, generates an LLDP packet, and advertises the LLDP packet to the neighboring network device. When the status information of the local network device does not change, the local network device periodically extracts the status information from the local MIB, generates an LLDP packet, and advertises the LLDP packet to the neighboring network device. In an implementation, “neighboring network device” may be referred to as an LLDP neighbor. For example, the R1 is an LLDP neighbor of the R0, and the R0 is also an LLDP neighbor of the R1. The managed devices (the R0, the R1, the R2, the R3, the R4, and the R5) each may send a notification message to the management device. The notification message includes status information extracted from a local MIB of the managed device and status information extracted from a remote MIB of the managed device. The notification message may be a (Simple Network Management Protocol (SNMP) message. In a possible implementation, the managed device may include, in one notification message, the status information extracted from the local MIB of the managed device and the status information extracted from the remote MIB of the managed device. In another possible implementation, the managed device may include, in two notification messages, the status information extracted from the local MIB of the managed device and the status information extracted from the remote MIB of the managed device. The two notification messages are associated with each other. The management device receives notification messages reported by all managed devices within a management scope, so that the management device obtains status information in a local MIB of each managed device and status information in a remote MIB of each managed device. The management device determines a topology of the communications network based on the status information, that is, the management device obtains topology information of the communications network based on the status information. For example, in FIG. 1, the topology information of the communications network includes identification information of the R0, the R1, the R2, the R3, the R4, and the R5 and connection relationships between the R0, the R1, the R2, the R3, the R4, and the R5. Specifically, the connection relationship includes: information about a communications link between the R0 and the R1, information about a communications link between the R1 and the R2, information about a communications link between the R2 and the R3, information about a communications link between the R3 and an R6, information about a communications link between the R1 and the R4, and information about a communications link between the R3 and the R4. It should be understood that, in the implementations, “status information” shall not be construed as information describing a status in a narrow sense. The “status information” may be understood as link layer information, and may include device information, port information, configuration information, system description information, and/or the like. In a possible implementation, the “status information” may include information that may be included in an LLDP packet defined in IEEE802.1AB, and the “status information” further includes slice information (for example, first slice information and second slice information).

FIG. 2 is a schematic structural diagram of another communications network according to an embodiment. A physical structure of the communications network shown in FIG. 2 is the same as that of the communications network shown in FIG. 1. That is, a physical topology of the communications network shown in FIG. 2 is the same as that of the communications network shown in FIG. 1. In FIG. 2, an R0, an R1, an R2, an R3, and an R5 are sequentially connected through communications links, the R1 is further connected to the R4 through a communications link, and the R3 is further connected to the R4 through a communications link. A difference between the communications network shown in FIG. 2 and the communications network shown in FIG. 1 lies in that the communications network shown in FIG. 2 includes a plurality of network slices. In FIG. 2, the communications network includes a network slice 1 (which is denoted by dotted lines in FIG. 2), a network slice 2 (which is denoted by dashed lines in FIG. 2), and a network slice 3 (which is denoted by solid lines in FIG. 2). The network slice 1 includes the R0, the R1, the R2, the R3, the R4, R5, and communications links between the R0, the R1, the R2, the R3, the R4, and the R5. The network slice 2 includes the R0, the R1, the R2, the R3, the R4, R5, and communications links between the R0, the R1, the R2, the R3, the R4, and the R5. The network slice 3 includes the R0, R1, R3, R4, R5, and communications links between the R0, the R1, the R3, the R4, and the R5. In this case, a port on a network device may belong to different slices. For example, a first port of the R0 is connected to a second port of the R1 through a communications link. The first port belongs to the network slice 1, the network slice 2, and the network slice 3. Different network slices can be distinguished between each other by using slice identifiers (IDs). For example, a slice ID-1 identifies the network slice 1, a slice ID-2 identifies the network slice 2, and a slice ID-3 identifies the network slice 3. As shown in FIG. 2, network devices and connection relationships included in the network slice 1 are the same as those included in the network slice 2. However, because the slice ID-1 is different from the slice ID-2, the network slice 1 and the network slice 2 are identified as different network slices.

Similar to FIG. 1, the communications network shown in FIG. 2 further includes a management device (which is not shown in FIG. 2). The management device separately communicates with the R0, the R1, the R2, the R3, the R4, and the R5. LLDP can be run on the R0, the R1, the R2, the R3, the R4, and the R5. The R0, the R1, the R2, the R3, the R4, and R5 send LLDP packets to respective neighboring network devices. In this way, the R0, the R1, the R2, the R3, the R4, and the R5 can learn of status information of their neighboring network devices based on the LLDP. The R0, the R1, the R2, the R3, the R4, and R5 each can send a notification message to the management device, so that the management device obtains status information in a local MIB of each managed device (the R0, the R1, the R2, the R3, the R4, and the R5) and status information in a remote MIB of each managed device. The management device determines topology information of the communications network based on the status information. Because the physical structure of the communications network shown in FIG. 2 is the same as that of the communications network shown in FIG. 1, the topology information obtained by the management device in FIG. 2 is the same as that obtained by the management device in FIG. 1. Therefore, based on an existing LLDP implementation, after collecting status information of each managed device, the management device cannot determine slice information in the network based on the status information. Consequently, the management device cannot determine the topology information of the network slice.

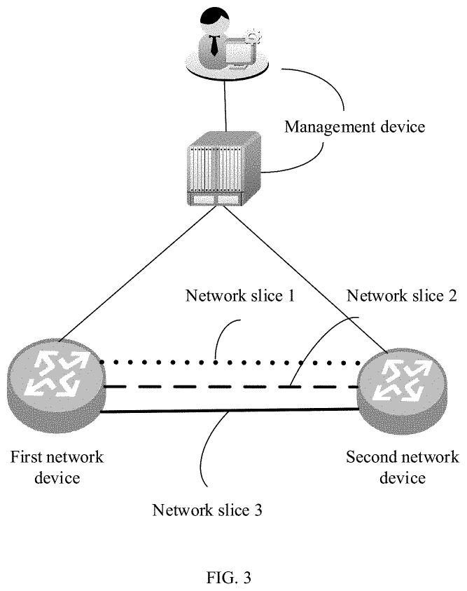

To resolve foregoing problem, this disclosure provides a corresponding solution. FIG. 3 is a schematic structural diagram of still another communications network according to an embodiment. As shown in FIG. 3, the communications network includes a first network device, a second network device, and a management device. A first port of the first network device is connected to a second port of the second network device through a communications link. The first network device and the second network device separately communicate with the management device. The communications network shown in FIG. 3 may be considered as a part of the communications network shown in FIG. 2. For example, the first network device may be the R0 in FIG. 2, and the second network device may be the R1 in FIG. 2. The management device may include a control device and a client device. The client device may provide a man-machine interaction interface for a network administrator, and the client device manages the first network device and the second network device by using the control device. In a possible implementation, the management device may be a network management system (NMS). In another possible implementation, the management device may include only a control device.

Similar to FIG. 2, the communications network in FIG. 3 includes a plurality of network slices. In FIG. 3, a communications network includes a network slice 1 (which is denoted by dotted lines in FIG. 3), a network slice 2 (which is denoted by dashed lines in FIG. 3), and a network slice 3 (which is denoted by solid lines in FIG. 3). A slice ID-1 identifies the network slice 1, a slice ID-2 identifies the network slice 2, and a slice ID-3 identifies the network slice 3.

Based on the foregoing description, the first network device and the second network device can advertise an LLDP packet to each other, to advertise their own status information to a neighboring network device. For example, the first network device sends an LLDP packet to the second network device. The LLDP packet includes slice information, and the slice information is used to indicate a network slice to which the first port of the first network device belongs, for example, a network slice 1. The first port is connected to the second port of the second network device through a communications link of the network slice 1. In a possible implementation, the slice information includes a slice identifier (the slice ID-1) of the network slice 1. The second network device receives the LLDP packet. In this way, the second network device can obtain status information of the first network device, and the status information includes the slice information. The second network device generates a notification message based on the LLDP packet. The notification message includes the slice information of the first network device. The notification message may further include slice information of the second network device. Then, the second network device sends the notification message to the management device. After receiving the notification message, the management device obtains the slice information of the first network device and the slice information of the second network device. Similarly, the second network device may also send an LLDP packet to the first network device. The first network device may also send a notification message to the management device. In this case, the management device can obtain, based on the LLDP, the status information reported by the first network device and the status information reported by the second network device. Compared with that in the implementation of FIG. 1, information that is obtained by the management device and that is reported by the first network device and the second network device includes the slice information of the first network device and the slice information of the second network device. Therefore, the management device can determine topology information of the network slice (the network slice 1) based on the slice information of the first network device and the slice information of the second network device.

In the implementation of FIG. 2 or FIG. 3, a network device may obtain slice information of a neighboring network device based on an extended LLDP packet. In addition, the network device includes the slice information in a notification message reported to the management device. The management device can obtain slice information of a managed device based on the notification message. In addition, the management device can determine topology information of a network slice of the communications network based on the obtained slice information.

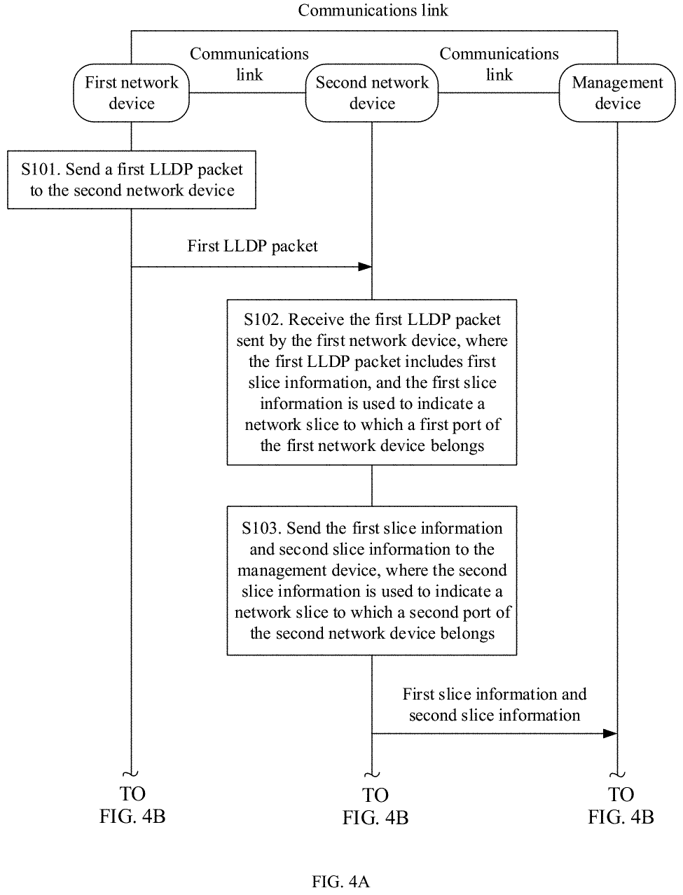

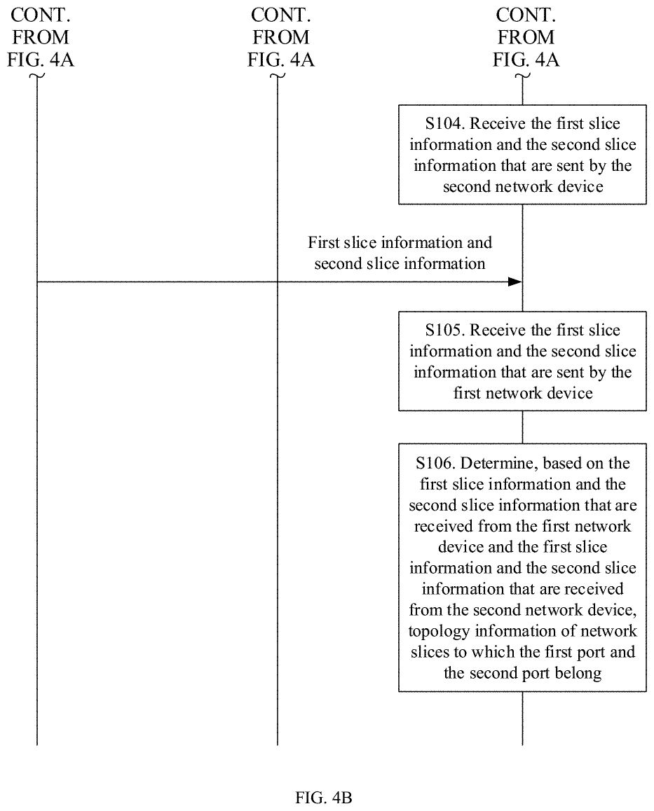

FIG. 4A and FIG. 4B are a flowchart of a network topology discovery method according to an embodiment. The method shown in FIG. 4A and FIG. 4B may be applied to the network structure shown in FIG. 2 or FIG. 3. In an implementation, for ease of description, a “first network device” and a “second network device” are used for description. It should be understood that the “first network device” is, for example, the router R0 in FIG. 2, and the “second network device” is, for example, the router R1 in FIG. 2. Specifically, the method includes the following steps.

S101: A first network device sends a first LLDP packet to a second network device.

S102: The second network device receives the first LLDP packet sent by the first network device, where the first LLDP packet includes first slice information, and the first slice information is used to indicate a network slice to which a first port of the first network device belongs.

Refer to FIG. 3. The first network device is a neighboring network device of the second network device, and the second network device is also a neighboring network device of the first network device. LLDP is run on both the first network device and the second network device. In other words, the first network device is an LLDP neighbor of the second network device, and the second network device is also an LLDP neighbor of the first network device. The first network device and the second network device can send an LLDP packet to each other, to advertise respective status information to each other. In this implementation, an example in which the first network device sends the first LLDP packet to the second network device is used for description.

It can be learned from FIG. 3 that three network slices are included between the first network device and the second network device: a network slice 1, a network slice 2, and a network slice 3. A slice identifier of the network slice 1 is a slice ID-1, a slice identifier of the network slice 2 is a slice ID-2, and a slice identifier of the network slice 3 is a slice ID-3. The first network device generates the first LLDP packet based on status information in a local MIB, and sends the first LLDP packet to the second network device. The first LLDP packet includes the first slice information, and the first slice information is used to indicate the network slice to which the first port of the first network device belongs. In other words, it may be determined, by analyzing the first slice information, that the first port is a part of the network slice. The first network device may receive or send, through the first port, a packet on a path determined based on topology information of the network slice.

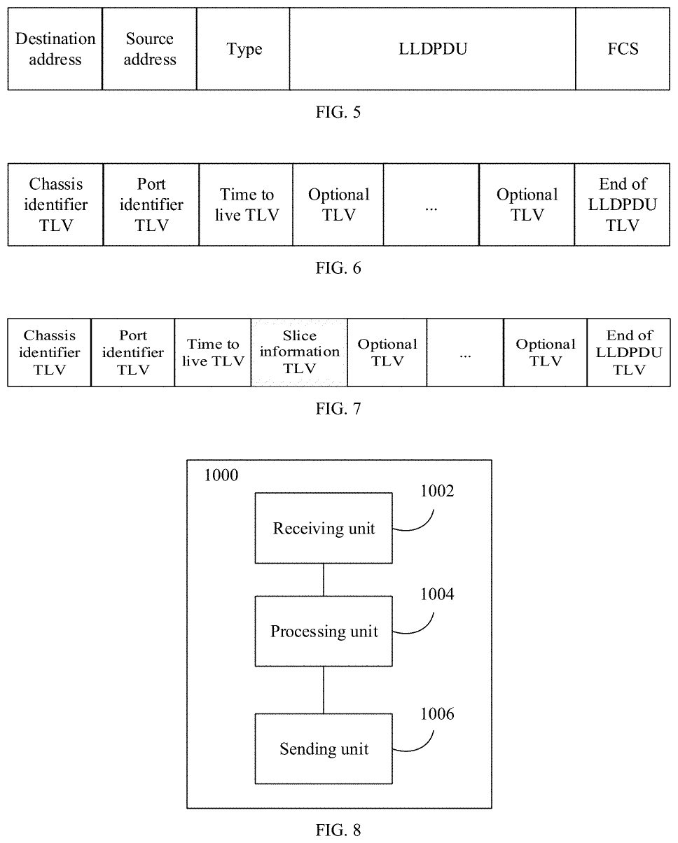

The following describes an implementation in which the first LLDP packet carries the first slice information. FIG. 5 shows a format of the first LLDP packet. The first LLDP packet includes a destination address, a source address, a type, an LLDPDU, and a frame check sequence (FCS). The destination address is a multicast address, and has a value of 01-80-C2-00-00-0E. The source address is a media access control (MAC) address of a sending node or a sending port. The type is used to indicate an LLDP encapsulation type. The LLDPDU is an entity for exchanging LLDP information. The FCS is used for frame check.

FIG. 6 shows a format of the LLDPDU in the first LLDP packet. The LLDPDU includes a plurality of type-length-values (TLVs). Specifically, the LLDPDU includes a chassis identifier (ID) TLV, a port ID TLV, a time-to-live (TTL) TLV, an optional TLV, and an end of LLDPDU TLV. The chassis identifier TLV identifies a bridge MAC address of a device that sends the LLDPDU. The port identifier TLV identifies a port of an LLDPDU transmit end. The time to live TLV identifies how long device information will be valid on a neighboring node. The three types of TLVs are basic TLVs in the LLDPDU. The LLDPDU may include a plurality of optional TLVs. In an implementation, at least one optional TLV may be used to carry the first slice information. As shown in FIG. 7, the LLDPDU includes slice information TLV, and the slice information TLV is used to carry the first slice information. The slice information TLV includes a type field, a length field, and a value field. The type field indicates that the slice information TLV is used to carry the slice information. The length field is used to indicate a length of content of the slice information TLV. The value field is used to carry content of the slice information.

In a possible implementation, the first slice information includes a first slice identifier, and the first slice identifier is used to identify a network slice. For example, if a value of the first slice identifier is the slice ID-1, the first slice identifier is used to indicate the network slice 1. According to the foregoing description, the LLDPDU in the first LLDP packet already includes the chassis identifier TLV and the port identifier TLV. The chassis identifier TLV is used to carry a chassis identifier, and the chassis identifier is used to identify the first network device. Therefore, the chassis identifier may be considered as a device identifier of the first network device. The port identifier TLV is used to carry a port identifier, and the port identifier is used to identify the first port. After receiving the first LLDP packet, the second network device can determine, based on the chassis identifier and the port identifier in the first LLDP packet, that the first slice identifier indicates the network slice (for example, the network slice 1) to which the first port of the first network device belongs. In this implementation, the first slice information does not need to include a device identifier or a port identifier. Instead, the device identifier and the port identifier are obtained by reading values in the chassis identifier TLV and the port identifier TLV in the LLDPDU in the first LLDP.

Based on the foregoing implementation, a variant implementation is as follows: Content carried in the slice information TLV included in the LLDPDU is the first slice identifier rather than the first slice information. In this case, the first slice information is considered as being in a larger range. In other words, a value of the slice information TLV included in the LLDPDU, a value of the chassis identifier TLV included in the LLDPDU, and a value of the port identifier TLV included in the LLDPDU may be included in the first slice information.

In still another possible implementation, the first slice information includes a first slice identifier. A value of the first slice identifier is divided into three parts by length. In other words, the value of the first slice identifier is divided into three parts in sequence from most significant bits of the value of the first slice identifier to least significant bits of the value of the first slice identifier. The first part is used to identify the first network device, the second part is used to identify the first port, and the third part is used to carry a value of a slice identifier (for example, the slice ID-1). In this way, the first slice identifier can indicate values of the device identifier, the port identifier, and the slice identifier. After receiving the first LLDP packet, the second network device can determine, based on the first slice identifier, that the first slice identifier indicates the network slice (for example, the network slice 1) to which the first port of the first network device belongs. The second network device may not need to obtain corresponding data from the chassis identifier TLV and the port identifier TLV in the LLDPDU.

In the foregoing implementation, the first slice information further includes a first port bandwidth, and the first port bandwidth is used to indicate an available bandwidth of the first port. The first port bandwidth may be carried in an optional TLV in the LLDPDU. Alternatively, a value of the first slice identifier may be divided into four parts by length according to the foregoing method. In addition to the content carried in the foregoing three parts, the fourth part is used to identify the first port bandwidth.

The foregoing implementation is described by using an example in which the first network device sends the first LLDP packet to the second network device. Similarly, the second network device may also send an LLDP packet, for example, a second LLDP packet, to the first network device. The second LLDP packet includes second slice information, and the second slice information is used to indicate a network slice (for example, the network slice 1) to which a second port of the second network device belongs. For specific implementations of the second LLDP packet and the second slice information, refer to the specific implementations of the first LLDP packet and the first slice information. Details are not described herein again.

After generating the first LLDP packet, the first network device sends the first LLDP packet to the second network device. Specifically, the first network device can send the first LLDP packet to the second network device through the first port. The second network device receives the first LLDP packet. Specifically, the second network device can receive the first LLDP packet through the second port of the second network device.

S103: The second network device sends the first slice information and the second slice information to a management device, where the second slice information is used to indicate the network slice to which the second port of the second network device belongs.

After receiving the first LLDP packet, the second network device parses the first LLDP packet. The second network device obtains status information of the first network device included in the first LLDP packet. Specifically, the second network device obtains the plurality of TLVs included in the LLDPDU in the first LLDP packet, to obtain the status information of the first network device. In an implementation, the status information of the first network device includes the first slice information. For an implementation of the first slice information, refer to the foregoing implementation. The status information of the first network device may further include one or more types of the following information related to the first network device: a device identifier, an interface identifier, a system name, a system description, an interface description, a device capability, and a network management address. The second network device can store the obtained status information of the first network device in a remote MIB of the second network device. Similarly, if a neighboring network device of the second network device further includes a third network device, and the remote MIB of the second network device is further used to store status information of the third network device.

The second network device further includes a local MIB. Similarly, the local MIB of the second network device is used to store status information of the second network device. The status information of the second network device includes the second slice information mentioned above, and the second slice information is used to indicate the network slice to which the second port of the second network device belongs. The status information of the second network device may further include one or more types of the following information related to the second network device: a device identifier, an interface identifier, a system name, a system description, an interface description, a device capability, and a network management address.

In the foregoing implementation, the first port of the first network device exchanges an LLDP packet with the second port of the second network device. Therefore, the first network device and the second network device are LLDP neighbors. In other words, the first port of the first network device and the second port of the second network device are LLDP neighbors. When there is no configuration error, the first port and the second port belong to a same network slice. Accordingly, the first slice identifier in the first slice information is the same as a second slice identifier in the second slice information.

Similarly, the first network device includes the local MIB and a remote MIB. The local MIB of the first network device is used to store the status information of the first network device. The remote MIB of the first network device is used to store the status information of the second network device.

In the foregoing implementation, the second network device can determine the status information of the first network device based on the first LLDP packet.

When the local MIB of the first network device changes, the first network device can determine that the status information of the first network device changes. Then, the first network device extracts status information from a current local MIB of the first network device, and sends a third LLDP packet to the second network device. The third LLDP packet includes the status information of the first network device.

When the local MIB of the first network device does not change, the first network device extracts the status information of the first network device based on a specific period, and sends a third LLDP packet to the second network device. The third LLDP packet includes the status information of the first network device.

In the foregoing implementation, the third LLDP packet includes third slice information, and the third slice information is used to indicate a network slice (for example, the network slice 1) to which the first port of the first network device belongs at a second moment. Correspondingly, the first slice information is used to indicate a network slice to which the first port of the first network device belongs at a first moment, and the first moment is different from the second moment. If a change of the local MIB of the first network device causes a change of topology information of a network slice (for example, the network slice 1) related to the first network device, the third slice information is different from the first slice information mentioned above. If a change of the local MIB of the first network device does not cause a change of topology information of a network slice (for example, the network slice 1) related to the first network device, or the local MIB of the first network device does not change, the third slice information is the same as the first slice information mentioned above. After receiving the third LLDP packet, the second network device can update the remote MIB of the second network device based on the status information of the first network device in the third LLDP packet. In this way, if topology information related to a network device in a network slice changes, the network device can advertise, through an LLDP packet, a neighboring network device to update a corresponding remote MIB, so that the network device can learn of a change of the topology information of the network slice of the neighboring network device of the network device in a timely manner.

Based on the foregoing implementation, in a possible implementation, after the second network device receives the LLDP packet sent by the first network device, the second network device compares the status information of the first network device in the LLDP packet with status information of the first network device stored in the remote MIB. When the second network device determines that the status information of the first network device in the LLDP packet is different from the status information of the first network device stored in the remote MIB, the second network device updates the remote MIB based on the LLDP packet. On the contrary, if the status information of the first network device in the LLDP packet is the same as the status information of the first network device stored in the remote MIB, the second network device does not update the remote MIB.

The second network device can obtain the first slice information from the remote MIB and obtain the second slice information from the local MIB. Then, the second network device sends the first slice information and the second slice information to the management device. The second slice information is used to indicate the network slice to which the second port of the second network device belongs. In a possible implementation, the second network device obtains the status information of the first network device from the remote MIB. The status information of the first network device includes the first slice information. The second network device obtains the status information of the second network device from the local MIB. The status information of the second network device includes the second slice information. Then, the second network device sends the status information of the first network device and the status information of the second network device to the management device.

The second network device can generate a first notification message. The first notification message includes the first slice information and the second slice information. In a possible implementation, the first notification message includes the status information of the first network device and the status information of the second network device, the status information of the first network device includes the first slice information, and the status information of the second network device includes the second slice information. In a possible implementation, the first notification message includes two notification messages: a notification message 1 and a notification message 2. The notification message 1 includes the first slice information or the status information of the first network device, and the notification message 2 includes the second slice information or the status information of the second network device. For example, the second network device extracts the status information of the second network device from the local MIB, and the second network device extracts the status information of the first network device from the remote MIB. Then, the second network device generates the first notification message, and then the second network device sends the first notification message to the management device. In a similar implementation, the first network device sends the first slice information and the second slice information to the management device; or the second network device sends the status information of the first network device and the status information of the second network device to the management device. The first network device can generate a third notification message. An implementation of the third notification message is similar to that of the first notification message, and details are not described herein again.

S104: The management device receives the first slice information and the second slice information that are sent by the second network device.

S105: The management device receives the first slice information and the second slice information that are sent by the first network device.

According to the foregoing implementation, the second network device can generate the first notification message. The first notification message includes the first slice information and the second slice information. As shown in FIG. 3, after generating the first notification message, the second network device sends the first notification message to the management device. In an implementation, the first notification message may also be referred to as an LLDP alarm message. In a possible implementation, the second network device may send the first notification message to the management device based on a network management protocol. For example, the first notification message is a Network Configuration Protocol (NETCONF) message, an SNMP message, or a RESTful message. The SNMP message may be specifically an SNMP trap message. In still another possible implementation, the first notification message may be a Border Gateway Protocol link state (BGP-LS) message. In still another possible implementation, the second network device sends the first notification message to the management device based on a telemetry technology. For example, the first notification message is an in-situ flow information telemetry (iFIT) packet.

In a possible implementation, the second network device proactively reports a notification message to the management device. For example, after receiving, for the first time, an LLDP packet sent by a neighboring network device, the second network device proactively sends a notification message to the management device. For another example, each time the second network device receives an LLDP packet sent by a neighboring network device, the second network device proactively sends a notification message to the management device. For another example, after detecting that the local MIB and/or the remote MIB change/changes, the second network device extracts status information from the local MIB and the remote MIB, and proactively sends, through a notification message, the status information to the management device.

Further, after detecting that the local MIB and/or the remote MIB change/changes, the second network device may send the status information in the local MIB and the remote MIB to the management device. For example, the second network device sends slice information in the local MIB and slice information in the remote MIB to the management device. Alternatively, after detecting that the local MIB and/or the remote MIB change/changes, the second network device may send changed status information to the management device. For example, when the second network device detects that the remote MIB changes but the local MIB does not change, the second network device sends slice information in the remote MIB to the management device.

In another possible implementation, the second network device sends a notification message based on a request message of the management device. For example, the management device sends a request message to a network device managed by the management device. The second network device serves as the managed device and can receive the request message. The second network device sends a notification message to the management device based on the request message. The request message is used by the management device to request status information from the network device managed by the management device. For example, the management device sends the request message to the network device, to obtain device information or port information of the network device. In an implementation, the request message is further used by the management device to request slice information from the network device managed by the management device. In a similar implementation, the request message may be a NETCONF message, an SNMP message, or a BGP-LS message. Alternatively, the request message is implemented based on a telemetry technology.

The foregoing implementation of proactive reporting and the implementation based on reporting of a request message may be used together. For example, a notification message sent by the second network device to the management device for the first time is sent based on a request message of the management device. In a subsequent running process of a communications network, the second network device periodically and proactively sends a notification message to the management device. Alternatively, after detecting that the local MIB and/or the remote MIB change/changes, the second network device proactively sends a notification message to the management device.

Similarly, the first network device can send a third notification message to the management device. An implementation of the third notification message is similar to that of the first notification message, and details are not described herein again.

S106: The management device determines, based on the first slice information and the second slice information that are received from the first network device and the first slice information and the second slice information that are received from the second network device, topology information of network slices to which the first port and the second port belong.

The management device parses the first notification message after receiving the first notification message sent by the second network device. In this case, the management device obtains the first slice information and the second slice information from the first notification message. Similarly, the management device can further receive the third notification message sent by the first network device, and parse the third notification message. In this case, the management device obtains the first slice information and the second slice information from the third notification message. The management device can determine, based on the first slice information and the second slice information that are received from the first network device and the first slice information and the second slice information that are received from the second network device, that the first port of the first network device and the second port of the second network device are LLDP neighbors. In this case, the management device can determine the topology information of the network slice (for example, the network slice 1) to which the first port and the second port belong. Therefore, the first slice information and the second slice information are used to generate the topology information of the network slice (for example, the network slice 1). In an implementation, managed devices in a communications network send an LLDP packet to each other, to advertise status information to each other. In addition, all of the managed devices in the communications network can send a notification message to the management device. As described in the foregoing implementations, both the first network device and the second network device can send a notification message to the management device. In this way, the management device can obtain duplicate slice information. The management device performs verification and deduplication based on specific duplicate information. This implementation helps the management device more accurately learn of the topology information of the network slice, to generate more accurate topology information of the network slice. The first slice information is used as an example. For the notification message sent by the second network device, the first slice information is obtained from the remote MIB of the second network device. For the notification message sent by the first network device, first slice information is obtained from the local MIB of the first network device. The management device can compare content of the two pieces of first slice information, to determine whether the slice information reported by the first network device and the second network device is correct and further determine whether the topology information is accurate. In this implementation, the topology information of the network slice to which the first port and the second port belong indicates that the first port of the first network device is directly connected to the second port of the second network device, that is, indicates that there is a direct link between the first port of the first network device and the second port of the second network device.

In a process of determining topology information of a network slice, the management device may use the slice identifier as index information, to distinguish between topology information of different network slices. For example, with reference to FIG. 3, the management device can determine, based on the first slice information, that the first slice information indicates that the slice identifier is the slice ID-1, the device identifier is an identifier of the first network device, and the port identifier is an identifier of the first port of the first network device. The first slice information is expressed as, for example, (slice ID-1, device-1, port-1). The management device can determine, based on the second slice information, that the second slice information indicates that the slice identifier is the slice ID-1, the device identifier is an identifier of the second network device, and the port identifier is an identifier of the second port of the second network device. The second slice information is expressed as, for example, (slice ID-1, device-2, port-2). In this case, the network device can determine, based on the first slice information and the second slice information, that the first port of the first network device and the second port of the second network device belong to the network slice 1. The topology information of the network slice 1 may include the first port of the first network device, the second port of the second network device, and a connection relationship between the first port and the second port. In addition, the management device may use the slice ID-1 as the slice identifier of the network slice 1, to distinguish the network slice 1 from other network slices.

Similarly, topology information of each network slice in FIG. 2 may be determined in the foregoing implementations. Specifically, the topology information of the network slice 1 in FIG. 2 includes: a port 1 of the R0, a port 1 of the R1, and a connection relationship between the port 1 of the R0 and the port 1 of the R1; a port 2 of the R1, a port 1 of an R2, and a connection relationship between the port 2 of the R1 and the port 1 of the R2; a port 2 of the R2, a port 1 of an R3, and a connection relationship between the port 2 of the R2 and the port 1 of the R3; a port 2 of the R3, a port 1 of an R5, and a connection relationship between the port 2 of the R3 and the port 1 of the R5; a port 3 of the R1, a port 1 of an R4, and a connection relationship between the port 3 of the R1 and the port 1 of the R4; and a port 2 of the R4, a port 3 of the R3, and a connection relationship between the port 2 of the R4 and the port 3 of the R3. The topology information of the network slice 1 further includes the slice ID-1 (slice identifier). The topology information of the network slice 2 in FIG. 2 includes: the port 1 of the R0, the port 1 of the R1, and the connection relationship between the port 1 of the R0 and the port 1 of the R1; the port 2 of the R1, the port 1 of the R2, and the connection relationship between the port 2 of the R1 and the port 1 of the R2; the port 2 of the R2, the port 1 of the R3, and the connection relationship between the port 2 of the R2 and the port 1 of the R3; the port 2 of the R3, the port 1 of the R5, and the connection relationship between the port 2 of the R3 and the port 1 of the R5; the port 3 of the R1, the port 1 of the R4, and the connection relationship between the port 3 of the R1 and the port 1 of the R4; and the port 2 of the R4, the port 3 of the R3, and the connection relationship between the port 2 of the R4 and the port 3 of the R3. The topology information of the network slice 2 further includes the slice ID-2. It can be learned that the node devices and the connection relationship in the network slice 2 are the same as the node devices and the connection relationship in the network slice 1. However, because the slice ID-1 is different from the slice ID-2, the network slice 1 and the network slice 2 belong to different network slices. The topology information of the network slice 3 in FIG. 2 includes: the port 1 of the R0, the port 1 of the R1, and the connection relationship between the port 1 of the R0 and the port 1 of the R1; the port 2 of the R3, the port 1 of the R5, and the connection relationship between the port 2 of the R3 and the port 1 of the R5; the port 3 of R1, the port 1 of the R4, and the connection relationship between the port 3 of the R1 and the port 1 of the R4; and the port 2 of the R4, the port 3 of the R3, and the connection relationship between the port 2 of the R4 and the port 3 of the R3. The topology information of the network slice 3 further includes the slice ID-3.

In an implementation, the first port of the first network device and the second port of the second network device are a peer of each other, and may also be referred to as a neighboring network device or an LLDP neighbor. That is, the first port is an LLDP peer of the second port, and the second port is an LLDP peer of the first port. The first slice identifier corresponding to the first port is the same as the second slice identifier corresponding to the second port. If the first network device or the second network device determines that the first slice identifier is different from the second slice identifier, an alarm may be triggered. For example, the first slice information includes a first slice identifier, the first slice identifier is used to identify the network slice to which the first port belongs, the second slice information includes a second slice identifier, and the second slice identifier is used to identify the network slice to which the second port belongs. The second network device receives the first LLDP packet sent by the first network device, and the first network device receives the second LLDP packet sent by the second network device. The first port is a receive port of the second LLDP packet, and the second port is a receive port of the first LLDP packet. The second network device determines whether the first slice identifier is the same as the second slice identifier. The second network device generates second alarm information if the second network device determines that the first slice identifier is different from the second slice identifier. The second alarm information is used to indicate that the slice information of the first port does not match the slice information of the second port. The second network device may display the second alarm information on an interaction interface of the second network device, or the second network device sends a second alarm message to the management device. The second alarm message includes the second alarm information. Similarly, if the first network device determines that the first slice identifier is different from the second slice identifier, the first network device generates a first alarm information. The first alarm information is used to indicate that the slice information of the first port does not match the slice information of the second port. The first network device may display the first alarm information on an interaction interface of the first network device, or the first network device sends the first alarm message to the management device. The first alarm message includes the first alarm information. If the second network device determines that the first slice identifier is the same as the second slice identifier, the second network device stores the first slice information. Specifically, the second network device stores the first slice information in the remote MIB of the second network device. Similarly, if the first network device determines that the first slice identifier is the same as the second slice identifier, the first network device stores the second slice information. Specifically, the first network device stores the second slice information in the remote MIB of the first network device.

In the foregoing implementation, when the network includes a network slice, the managed device includes slice information in an LLDP packet when sending the LLDP packet to a neighboring network device, so that the management device can obtain the slice information of the managed device in the network, and the management device can determine topology information of the managed device based on the obtained slice information.

FIG. 8 is a schematic structural diagram of a second network device 1000 according to an embodiment. The second network device 1000 shown in FIG. 8 can perform corresponding steps performed by the second network device in the methods in the foregoing embodiments. The second network device 1000 is deployed in a communications network, and the communications network further includes a first network device and a management device. As shown in FIG. 8, the second network device 1000 includes a receiving unit 1002 and a sending unit 1006.

The receiving unit 1002 is configured to receive a first LLDP packet sent by the first network device. The first LLDP packet includes first slice information, and the first slice information is used to indicate a network slice to which a first port of the first network device belongs.

The sending unit 1006 is configured to send the first slice information and second slice information to the management device. The second slice information is used to indicate a network slice to which a second port of the second network device 1000 belongs.

Optionally, the second network device further includes a processing unit 1004. The processing unit 1004 is configured to obtain the first slice information and the second slice information.

Optionally, before the sending unit 1006 sends the first slice information and the second slice information to the management device, the receiving unit 1002 is further configured to receive a request message sent by the management device, where the request message is used by the management device to request slice information from a network device managed by the management device.

Optionally, in the sending, by the sending unit 1006, the first slice information and the second slice information to the management device, the sending unit 1006 is further configured to send a first notification message to the management device. The first notification message includes the first slice information and the second slice information, and the first notification message is a NETCONF message.

Optionally, the receiving unit 1002 is further configured to receive a third LLDP packet sent by the first network device. The third LLDP packet includes third slice information, the third slice information is used to indicate a network slice to which the first port of the first network device belongs at a second moment, the first slice information is used to indicate a network slice to which the first port of the first network device belongs at a first moment, and the first moment is different from the second moment. The sending unit 1006 is further configured to send the third slice information to the management device.

Optionally, in the sending, by the sending unit 1006, the third slice information to the management device, the sending unit 1006 is further configured to send a second notification message to the management device. The second notification message includes the third slice information, and the second notification message is an SNMP trap message.

Optionally, the sending unit 1006 is further configured to send a second LLDP packet to the first network device. The second LLDP packet includes the second slice information.

Optionally, the first slice information includes a first slice identifier, the first slice identifier is used to identify the network slice to which the first port belongs, the second slice information includes a second slice identifier, the second slice identifier is used to identify the network slice to which the second port belongs, and the first slice identifier is the same as the second slice identifier.

Optionally, the first slice information further includes a first device identifier and a first port identifier, the first device identifier is used to indicate the first network device, the first port identifier is used to indicate the first port of the first network device, the second slice information further includes a second device identifier and a second port identifier, the second device identifier is used to indicate the second network device, and the second port identifier is used to indicate the second port of the second network device.

Optionally, the first slice information further includes a first port bandwidth, the first port bandwidth is used to indicate an available bandwidth of the first port, the second slice information further includes a second port bandwidth, and the second port bandwidth is used to indicate an available bandwidth of the second port.

Optionally, topology information of the network slice to which the first port and the second port belong includes the first slice identifier.

Optionally, the first slice information includes a first slice identifier, the first slice identifier is used to identify the network slice to which the first port belongs, the second slice information includes a second slice identifier, the second slice identifier is used to identify the network slice to which the second port belongs, the first port is a receive port of the second LLDP packet, and the second port is a receive port of the first LLDP packet. The processing unit 1004 is further configured to determine whether the first slice identifier is the same as the second slice identifier.

Optionally, the processing unit 1004 is further configured to generate alarm information in response to that the first slice identifier is different from the second slice identifier. The alarm information is used to indicate that slice information of the first port does not match slice information of the second port.

Optionally, the processing unit 1004 is further configured to store the first slice information in response to that the first slice identifier is the same as the second slice identifier.

The second network device 1000 shown in FIG. 8 can perform corresponding steps performed by the second network device in the methods in the foregoing embodiments. The second network device receives the first LLDP packet sent by the first network device, obtains the first slice information in the first LLDP packet and the locally stored second slice information, and then sends the first slice information and the second slice information to the management device, to help the management device determine the topology information of the network slice.

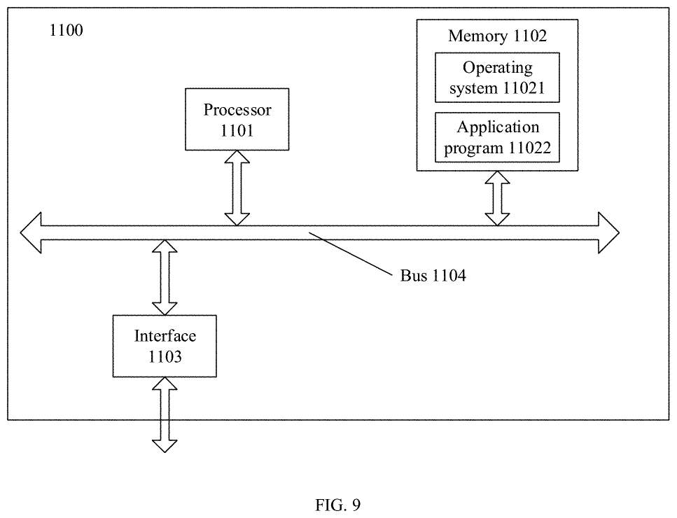

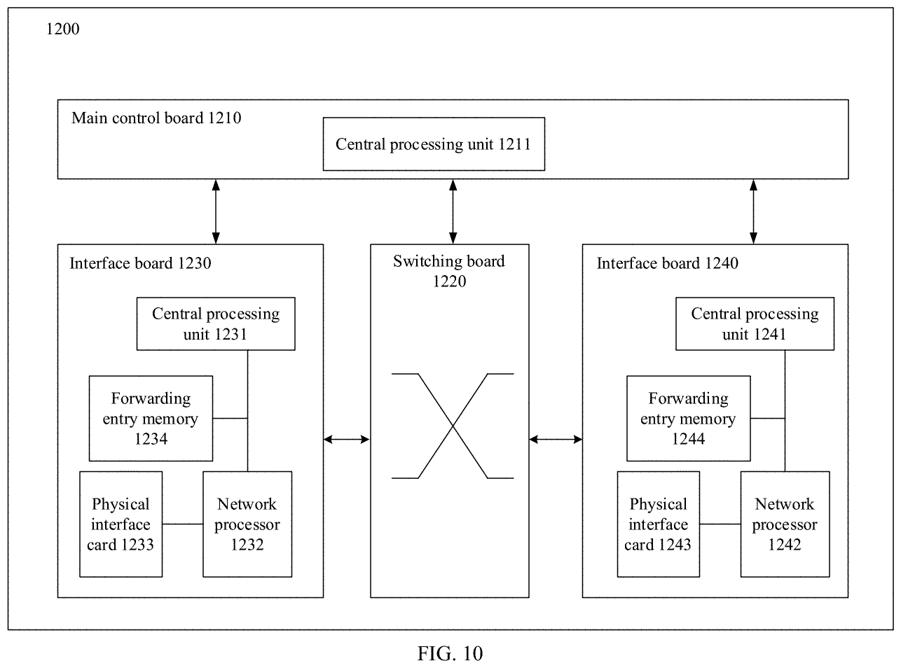

FIG. 9 is a schematic structural diagram of hardware of a second network device 1100 according to an embodiment. The second network device 1100 shown in FIG. 9 can perform corresponding steps performed by the second network device in the methods in the foregoing embodiments.

As shown in FIG. 9, the second network device 1100 includes a processor 1101, a memory 1102, an interface 1103, and a bus 1104. The interface 1103 may be implemented in a wireless or wired manner. The processor 1101, the memory 1102, and the interface 1103 are connected through the bus 1104.

The interface 1103 may specifically include a transmitter and a receiver. The interface 1103 is configured for the second network device to receive information from and send information to the first network device in the foregoing embodiments, and is configured for the second network device to receive information from and send information to the management device in the foregoing embodiments. For example, the interface 1103 is configured to support receiving of a first LLDP packet sent by the first network device. In addition, the interface 1103 is configured to support sending of first slice information and second slice information to the management device. For example, the interface 1103 is configured to support the processes S102 and S103 in FIG. 4A. The processor 1101 is configured to perform processing performed by the second network device in the foregoing embodiments. For example, the processor 1101 is configured to: perform an action of obtaining the first slice information and the second slice information, and/or perform another process used for the technology described in this specification. The memory 1102 is configured to store a program, code, or instructions, for example, store an operating system 11021 and an application program 11022. When executing the program, the code, or the instructions, the processor or a hardware device can complete a processing process related to the second network device in the method embodiments. Optionally, the memory 1102 may include a read-only memory (ROM) and a random-access memory (RAM). The ROM includes a basic input/output system (BIOS) or an embedded system, and the RAM includes an application program and an operating system. When the second network device 1100 needs to run, the BIOS built into the ROM or a bootloader in the embedded system is used to boot the system to start, and boot the second network device 1100 to enter a normal running state. After the second network device 1100 enters the normal running state, the application program and the operating system in the RAM are run, to complete processing procedures of the second network device in the method embodiments.

It may be understood that FIG. 9 shows only a simplified design of the second network device 1100. In actual application, the second network device may include any quantity of interfaces, processors, or memories.

FIG. 10 is a schematic structural diagram of hardware of another second network device 1200 according to an embodiment. The second network device 1200 shown in FIG. 10 can perform corresponding steps performed by the second network device in the method in the foregoing embodiments.

As shown in FIG. 10, the second network device 1200 includes a main control board 1210, an interface board 1230, a switching board 1220, and an interface board 1240. The main control board 1210, the interface board 1230, the interface board 1240, and the switching board 1220 are connected to a system backplane through a system bus for communication. The main control board 1210 is configured to complete functions such as system management, device maintenance, and protocol processing. The switching board 1220 is configured to exchange data between interface boards (where the interface board is also referred to as a line card or a service board). The interface board 1230 and the interface board 1240 are configured to provide various service interfaces (for example, a POS interface, a GE interface, and an ATM interface), and forward a data packet.

The interface board 1230 may include a central processing unit 1231, a forwarding entry memory 1234, a physical interface card 1233, and a network processor 1232. The central processing unit 1231 is configured to control and manage the interface board, and communicate with a central processing unit on the main control board. The forwarding entry memory 1234 is configured to store a forwarding entry. The physical interface card 1233 is configured to receive and send traffic. The network processor 1232 is configured to control, based on the forwarding entry, the physical interface card 1233 to receive and send the traffic.

Specifically, the physical interface card 1233 is configured to receive a first LLDP packet sent by the first network device. The physical interface card 1233 is further configured to send first slice information and second slice information to a management device.

After receiving the first LLDP packet, the physical interface card 1233 sends the first LLDP packet to the central processing unit 1231. The central processing unit 1231 determines, based on information in a packet header of the first LLDP packet, that the first LLDP packet needs to be processed by the central processing unit 1231. Accordingly, the central processing unit 1231 processes the first LLDP packet.

Optionally, after receiving the LLDP packet, the physical interface card 1233 sends the LLDP packet to the central processing unit 1231. The central processing unit 1231 determines, based on information in a packet header of the first LLDP packet, that the first LLDP packet needs to be processed by the central processing unit 1211. The central processing unit 1231 sends the first LLDP packet to the central processing unit 1211, and the central processing unit 1211 processes the first LLDP packet.

The central processing unit 1231 is further configured to control the network processor 1232 to obtain the forwarding entry in the forwarding entry memory 1234, and the central processing unit 1231 is further configured to control the network processor 1232 to send the first slice information and the second slice information to the management device through the physical interface card 1233.

It should be understood that actions on the interface board 1240 are consistent with actions on the interface board 1230 in this embodiment. For brevity, details are not described. It should be understood that the second network device 1200 in this embodiment may correspond to the functions and/or the implemented steps in the foregoing method embodiments. Details are not described herein.

In addition, it should be noted that there may be one or more main control boards. When there are a plurality of main control boards, a primary main control board and a secondary main control board may be included. There may be one or more interface boards. A second network device having a stronger data processing capability provides more interface boards. There may also be one or more physical interface cards on the interface board. There may be no switching board or there may be one or more switching boards. When there are a plurality of switching boards, load sharing and redundancy backup may be implemented together. In a centralized forwarding architecture, there may be no switching board on the second network device, and the interface board provides a function of processing service data of an entire system. In a distributed forwarding architecture, there may be at least one switching board on the second network device, and the switching board is used to implement data exchange between a plurality of interface boards, to provide a large-capacity data exchange and processing capability. Therefore, a data access and processing capability of the second network device in the distributed architecture is higher than that of the second network device in the centralized architecture. A specific architecture that is to be used depends on a specific networking deployment scenario, and is not limited herein.

In addition, an embodiment provides a computer storage medium. The computer storage medium is configured to store computer software instructions used by the foregoing second network device, and includes a program designed for performing the foregoing method embodiments.

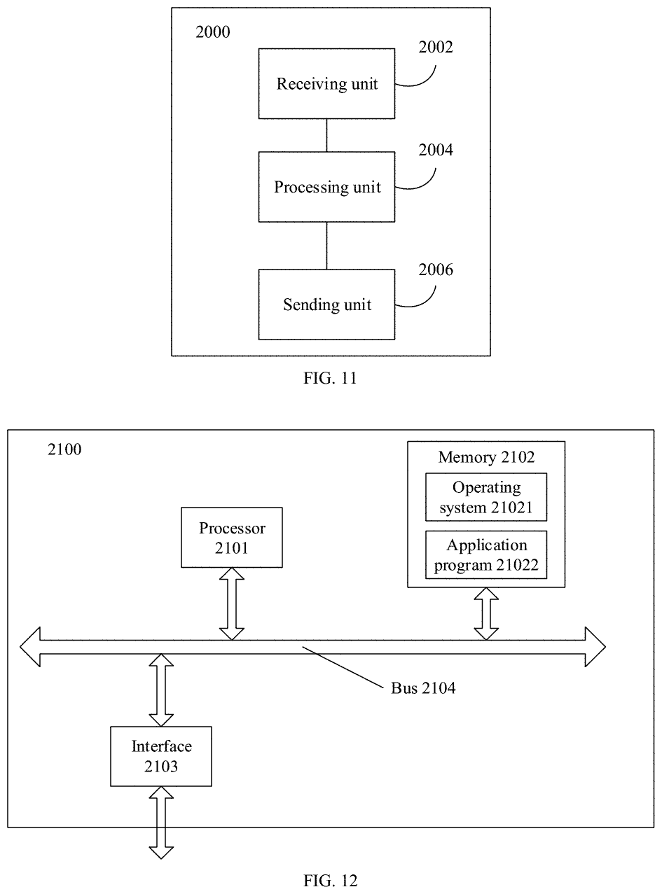

FIG. 11 is a schematic structural diagram of a management device 2000 according to an embodiment. The management device 2000 shown in FIG. 11 can perform corresponding steps performed by the management device in the methods in the foregoing embodiments. The management device is deployed in a communications network, and the communications network further includes a first network device and a second network device. As shown in FIG. 11, the management device 2000 includes a receiving unit 2002 and a processing unit 2004.

The receiving unit 2002 is configured to receive first slice information and second slice information that are sent by a second network device. The first slice information is used to indicate a network slice to which a first port of the first network device belongs, and the second slice information is used to indicate a network slice to which a second port of the second network device belongs.

The receiving unit 2002 is further configured to receive the first slice information and the second slice information that are sent by the first network device.

The processing unit 2004 is configured to determine, based on the first slice information and the second slice information that are received from the first network device and the first slice information and the second slice information that are received from the second network device, topology information of the network slices to which the first port and the second port belong. The topology information indicates that the first port of the first network device is directly connected to the second port of the second network device.

Optionally, the management device further includes a sending unit 2006. The sending unit 2006 is configured to send a request message to the second network device before the receiving unit 2002 receives the first slice information and the second slice information that are sent by the second network device. The request message is used by the management device to request slice information from a network device managed by the management device.

Optionally, in the receiving, by the receiving unit 2002, the first slice information and the second slice information that are sent by the second network device, the receiving unit 2002 is further configured to receive a first notification message sent by the second network device. The first notification message includes the first slice information and the second slice information, and the first notification message is a NETCONF message.

Optionally, the receiving unit 2002 is further configured to receive third slice information sent by the second network device. The third slice information is used to indicate a network slice to which the first port of the first network device belongs at a second moment, the first slice information is used to indicate a network slice to which the first port of the first network device belongs at a first moment, and the first moment is different from the second moment. The processing unit 2004 is further configured to update, based on the third slice information and the second slice information, the topology information of the network slices to which the first port and the second port belong.

Optionally, in the receiving, by the receiving unit 2002, the third slice information sent by the second network device, the receiving unit 2002 is further configured to receive a second notification message sent by the second network device. The second notification message includes the third slice information, and the second notification message is an SNMP trap message.

Optionally, the first slice information includes a first slice identifier, the first slice identifier is used to identify the network slice to which the first port belongs, the second slice information includes a second slice identifier, the second slice identifier is used to identify the network slice to which the second port belongs, and the second slice identifier is the same as the first slice identifier.

Optionally, the first slice information further includes a first device identifier and a first port identifier, the first device identifier is used to indicate the first network device, the first port identifier is used to indicate the first port of the first network device, the second slice information further includes a second device identifier and a second port identifier, the second device identifier is used to indicate the second network device, and the second port identifier is used to indicate the second port of the second network device.

Optionally, the first slice information further includes a first port bandwidth, the first port bandwidth is used to indicate an available bandwidth of the first port, the second slice information further includes a second port bandwidth, and the second port bandwidth is used to indicate an available bandwidth of the second port.

Optionally, the topology information of the network slice to which the first port and the second port belong includes the first slice identifier.

Optionally, the first network device is an LLDP neighbor of the second network device.

The management device 2000 shown in FIG. 11 can perform corresponding steps performed by the management device in the methods in the foregoing embodiments. The management device separately receives the first slice information and the second slice information that are sent by the first network device and the second network device. Then the management device determines, based on the first slice information and the second slice information, the topology information of the network slice to which the first port and the second port belong. The topology information indicates that the first network device is directly connected to the second network device. In this way, the management device can obtain slice information from a managed device, and determine a topology of the managed device based on the obtained slice information.

FIG. 12 is a schematic structural diagram of hardware of a management device 2100 according to an embodiment. The management device 2100 shown in FIG. 12 can perform corresponding steps performed by the management device in the method in the foregoing embodiments.

As shown in FIG. 12, the management device 2100 includes a processor 2101, a memory 2102, an interface 2103, and a bus 2104. The interface 2103 may be implemented in a wireless or wired manner. The processor 2101, the memory 2102, and the interface 2103 are connected through the bus 2104.

The interface 2103 may specifically include a transmitter and a receiver. The interface 2103 is configured to receive and send information or data between the management device and the second network device or the first network device in the foregoing embodiments. For example, the interface 2103 is configured to support receiving of first slice information and second slice information that are sent by the second network device. For another example, the interface 2103 is configured to support receiving of first slice information and second slice information that are sent by the first network device. For example, the interface 2103 is configured to support the processes S104 and S105 in FIG. 4B. The processor 2101 is configured to perform processing performed by the management device in the foregoing embodiments. For example, the processor 2101 is configured to: determine topology information of network slices based on the first slice information and the second slice information, and/or perform another process used for the technology described in this specification. For example, the processor 2101 is configured to support the process S106 in FIG. 4B. The memory 2102 includes an operating system 21021 and an application program 21022. The memory 2102 is configured to store a program, code, or instructions. When executing the program, the code, or the instructions, the processor or a hardware device can complete the processing process of the first network device in the foregoing method embodiments. Optionally, the memory 2102 may include a ROM and a RAM. The ROM includes a BIOS or an embedded system, and the RAM includes an application program and an operating system. When the management device 2100 needs to run, the BIOS built into the ROM or a bootloader in the embedded system is used to boot the system to start, and boot the management device 2100 to enter a normal running state. After the management device 2100 enters the normal running state, the application program and the operating system in the RAM are run, to complete processing procedures of the management device in the method embodiments.

It may be understood that FIG. 12 shows only a simplified design of the management device 2100. In actual application, the management device may include any quantity of interfaces, processors, or memories.

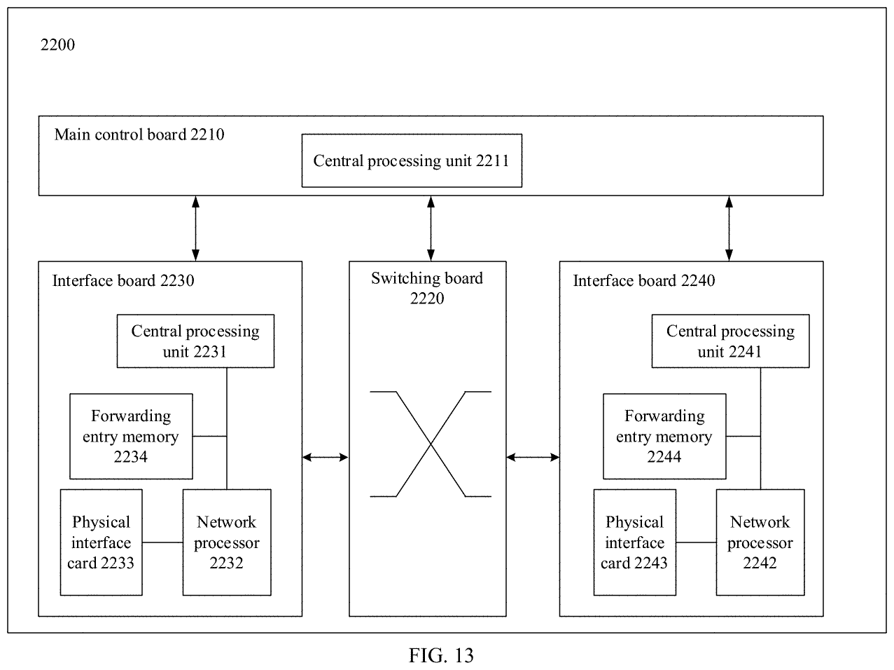

FIG. 13 is a schematic structural diagram of hardware of another management device 2200 according to an embodiment. The management device 2200 shown in FIG. 13 can perform corresponding steps performed by the management device in the method in the foregoing embodiments.

As shown in FIG. 13, the management device 2200 includes a main control board 2210, an interface board 2230, a switching board 2220, and an interface board 2240. The main control board 2210, the interface board 2230, the interface board 2240, and the switching board 2220 are connected to a system backplane through a system bus for communication. The main control board 2210 is configured to complete functions such as system management, device maintenance, and protocol processing. The switching board 2220 is configured to exchange data between interface boards (where the interface board is also referred to as a line card or a service board). The interface board 2230 and the interface board 2240 are configured to provide various service interfaces (for example, a POS interface, a GE interface, and an ATM interface), and forward a data packet. In a possible implementation, the management device 2200 is a blade server.

The interface board 2230 may include a central processing unit 2231, a forwarding entry memory 2234, a physical interface card 2233, and a network processor 2232. The central processing unit 2231 is configured to control and manage the interface board, and communicate with a central processing unit 2211 on the main control board 2210. The forwarding entry memory 2234 is configured to store a forwarding entry. The physical interface card 2233 is configured to receive and send traffic. The network processor 2232 is configured to control, based on the forwarding entry, the physical interface card 2233 to receive and send the traffic.

Specifically, the physical interface card 2233 is configured to: receive first slice information and second slice information that are sent by the second network device, or receive first slice information and second slice information that are sent by the first network device. The physical interface card 2233 is further configured to send a request packet.

In a possible implementation, the central processing unit 2211 generates a request packet, and sends the request packet to the central processing unit 2231. After passing through the physical interface card 2233, the request packet is sent to the second network device and the first network device.

In another possible implementation, the physical interface card 2233 receives the first slice information and the second slice information, and the central processing unit 2231 processes the first slice information and the second slice information, and sends the first slice information and the second slice information to the central processing unit 2211.

The central processing unit 2231 is further configured to control the network processor 2232 to obtain the forwarding entry in the forwarding entry memory 2234, and the central processing unit 2231 is further configured to control the network processor 2232 to receive and send the traffic through the physical interface card 2233.

It should be understood that actions on the interface board 2240 are consistent with actions on the interface board 2230 in this embodiment. For brevity, details are not described. It should be understood that the management device 2200 in this embodiment may correspond to functions and/or the implemented steps in the foregoing method embodiments. Details are not described herein.

In addition, it should be noted that there may be one or more main control boards. When there are a plurality of main control boards, a primary main control board and a secondary main control board may be included. There may be one or more interface boards. The first network device having a stronger data processing capability provides more interface boards. There may also be one or more physical interface cards on the interface board. There may be no switching board or there may be one or more switching boards. When there are a plurality of switching boards, load sharing and redundancy backup may be implemented together. In a centralized forwarding architecture, there may be no switching board on the first network device, and the interface board provides a function of processing service data of an entire system. In a distributed forwarding architecture, there may be at least one switching board on the first network device, and the switching board is used to implement data exchange between a plurality of interface boards, to provide a large-capacity data exchange and processing capability. Therefore, a data access and processing capability of the first network device in the distributed architecture is higher than that of the first network device in the centralized architecture. A specific architecture to be used depends on a specific networking deployment scenario, and is not limited herein.

In addition, an embodiment provides a computer storage medium. The computer storage medium is configured to store computer software instructions used by the foregoing management device, and includes a program designed for performing the foregoing method embodiments.

An embodiment further includes a network system. The network system includes a second network device and a management device. The second network device is the second network device in FIG. 8, FIG. 9, or FIG. 10, and the management device is the management device in FIG. 11, FIG. 12, or FIG. 13.

Method or algorithm steps described in combination with the content may be implemented by hardware, or may be implemented by a processor by executing software instructions. The software instructions may be formed by a corresponding software module. The software module may be located in a RAM memory, a flash memory, a ROM memory, an EPROM memory, an EEPROM memory, a register, a hard disk, a removable magnetic disk, a CD-ROM, or a storage medium of any other form known in the art. For example, a storage medium is coupled to a processor, so that the processor can read information from the storage medium or write information into the storage medium. Certainly, the storage medium may be a component of the processor. The processor and the storage medium may be located in an ASIC. In addition, the ASIC may be located in user equipment. Certainly, the processor and the storage medium may exist in user equipment as discrete components.

A person skilled in the art should be aware that in one or more of the foregoing examples, the functions described may be implemented by hardware or a combination of hardware and software. When is the embodiments are implemented by a combination of hardware and software, the software may be stored in a computer-readable medium or transmitted as one or more instructions or one or more pieces of code in a computer-readable medium. The computer-readable medium includes a computer storage medium and a communications medium. The communications medium includes any medium that enables a computer program to be transmitted from one place to another. The storage medium may be any available medium accessible to a general-purpose or dedicated computer.

The objectives, technical solutions, and beneficial effects of this disclosure are further described in detail in the foregoing specific implementations. It should be understood that the foregoing descriptions are merely specific implementations.

1. A method implemented by a second network device and comprising:
receiving, from a first network device, a first Link Layer Discovery Protocol (LLDP) packet comprising first slice information, wherein the first slice information indicates a first network slice to which a first port of the first network device belongs; and
sending, to a management device, the first slice information and second slice information,
wherein the second slice information indicates a second network slice to which a second port of the second network device belongs.

2. The method of claim 1, wherein before sending the first slice information and the second slice information, the method comprises receiving, from the management device, a request message requesting slice information.

3. The method of claim 1, further comprising further sending the first slice information and second slice information in a first notification message, wherein the first notification message is a Network Configuration Protocol (NETCONF) message.

4. The method of claim 1, further comprising:
receiving, from the first network device, a third LLDP packet comprising third slice information, wherein the third slice information indicates a third network slice to which the first port of the first network device belongs at a second moment, and wherein the first slice information further indicates the first network slice at a first moment; and
sending, to the management device, the third slice information.

5. The method of claim 4, further comprising further sending, the third slice information and the second slice information in a second notification message, wherein the second notification message is a Simple Network Management Protocol (SNMP) trap message.

6. The method of claim 1, further comprising sending, to the first network device, second LLDP packet comprising the second slice information.

7. The method 1, wherein the first slice information comprises a first slice identifier identifying the first network slice, wherein the second slice information comprises a second slice identifier identifying the second network slice, and wherein the first slice identifier is the same as the second slice identifier.

8. The method of claim 7, wherein the first slice information further comprises a first device identifier identifying the first network device and a first port identifier identifying the first port, and wherein the second slice information further comprises a second device identifying the second network device and a second port identifier identifying the second port.

9. The method of claim 7, wherein the first slice information further comprises a first port bandwidth indicating a first available bandwidth of the first port, and wherein the second slice information further comprises a second port bandwidth indicating a second available bandwidth of the second port.

10. The method of claim 7, wherein topology information of the first network slice and the second network slice comprises the first slice identifier and indicates that the first port is directly connected to the second port.

11. The method of claim 6, wherein the first slice information comprises a first slice identifier identifying the first network slice, wherein the second slice information comprises a second slice identifier identifying the second network slice, wherein the first port is a first receive port of the second LLDP packet, wherein the second port is a second receive port of the first LLDP packet, and wherein the method further comprises determining whether the first slice identifier is the same as the second slice identifier.

12. The method of claim 11, further comprises generating alarm information when the first slice identifier is different from the second slice identifier, wherein the alarm information indicates that the first slice information does not match the second slice information.

13. The method of claim 11, further comprises, storing the first slice information when the first slice identifier is the same as the second slice identifier.

14. A method implemented by a management device and comprising:
receiving, from a second network device, first slice information and second slice information, wherein the first slice information indicates a first network slice to which a first port of a first network device belongs, and wherein the second slice information indicates a second network slice to which a second port of the second network device belongs;
receiving, from the first network device, the first slice information and the second slice information; and
determining, based on the first slice information and the second slice information, topology information of the first network slice and the second network slice,
wherein the topology information indicates that the first port is directly connected to the second port.

15. The method of claim 14, wherein before receiving the first slice information and the second slice information, the method further comprises sending, to the second network device, a request message requesting slice information.

16. The method of claim 14, further comprising further receiving the first slice information and the second slice information in a first notification message, wherein the first notification message is a Network Configuration Protocol (NETCONF) message.

17. The method of claim 14, further comprising:
receiving, from the second network device, third slice information indicating a third network slice to which the first port of the first network device belongs at a second moment, wherein the first slice information further indicates the first network slice at a first moment; and
updating, based on the third slice information, the topology information.

18. The method of claim 17, comprising further receiving the third slice information and the second slice information in a second notification message, wherein the second notification message is a Simple Network Management Protocol (SNMP) trap message.

19. The method of claim 14, wherein the first slice information comprises a first slice identifier identifying the first network slice, wherein the second slice information comprises a second slice identifier, identifying the second network slice, and wherein the second slice identifier is the same as the first slice identifier.

20. The method of claim 19, wherein the first slice information further comprises a first device identifier identifying the first network device and a first port identifier identifying the first port, and wherein the second slice information further comprises a second device identifier identifying the second network device and a second port identifier identifying the second port.

21. A second network device comprising:
a memory configured to store instructions; and
a processor coupled to the memory and configured to execute the instructions to:
receive from a first network device, a first Link Layer Discovery Protocol (LLDP) packet comprising first slice information, wherein the first slice information indicates a first network slice to which a first port of the first network device belongs; and
send, to a management device, the first slice information and second slice information,
wherein the second slice information indicates a second network slice to which a second port of the second network device belongs.

22. The second network device of claim 21, wherein before sending the first slice information and the second slice information, the processor is further configured to receive, from the management device a request message requesting slice information.

23. The second network device of claim 21, wherein the processor is further configured to further send the first slice information and the second slice information in a first notification message, wherein the first notification message is a Network Configuration Protocol (NETCONF) message.

24. The second network device of claim 21, wherein the processor is further configured to:
receive, from the first network device, a third LLDP packet comprising third slice information, wherein the third slice information indicates a third network slice to which the first port of the first network device belongs at a second moment, and wherein the first slice information further indicates the first network slice at a first moment; and
send, to the management device, the third slice information.

25. The second network device of claim 24, wherein the processor is further configured to further send the third slice information and the second slice information in a second notification message, and wherein the second notification message is a Simple Network Management Protocol (SNMP) trap message.

26. A management device comprising:
a memory configured to store instructions; and
a processor coupled to the memory and configured to execute the instructions to:
receive, from a second network device, first slice information and second slice information, wherein the first slice information indicates a first network slice to which a first port of a first network device belongs, and wherein the second slice information indicates a second network slice to which a second port of the second network device belongs;
receive, from the first network device, the first slice information and the second slice information; and
determine, based on the first slice information and the second slice information, topology information of the first network slice and the second network slice,
wherein the topology information indicated that the first port is directly connected to the second port.

27. The management device of claim 26, wherein before receiving the first slice information and the second slice information, the processor is further configured to send, to the second network device, a request message requesting slice information.

28. The management device of claim 26, wherein the processor is further configured to further receive the first slice information and the second slice information in a first notification message, wherein the first notification message is a Network Configuration Protocol (NETCONF) message.

29. The management device of claim 26, wherein the processor is further configured to:
receive, from the second network device, third slice information indicating a third network slice to which the first port of the first network device belongs at a second moment, wherein the first slice information further indicates the first network slice at a first moment; and
update, based on the third slice information, the topology information.

30. The management device of claim 29, wherein the processor is further configured to further receive the third slice information and the second slice information in a second notification message, wherein the second notification message is a Simple Network Management Protocol (SNMP) trap message.
